(19) United States
(12) Patent Application Publication
(10) Pub. No.: US 2022/0357159 A1
(43) Pub. Date: Nov. 10, 2022

(54) Navigation Method, Navigation Apparatus, Electronic Device, and Storage Medium

(71) Applicant: Beijing Baidu Netcom Science Technology Co., Ltd., Beijing (CN)

(72) Inventor: Chunyu SONG, Beijing (CN)

(21) Appl. No.: 17/871,514

(22) Filed: Jul. 22, 2022

(30) Foreign Application Priority Data
Jul. 28, 2021 (CN) 202110856976.9

(51) Int. Cl. G01C 21/16; H04W 4/021; G01C 21/00; G01C 21/36

(52) U.S. Cl. CPC G01C 21/1656; H04W 4/021; G01C 21/005; G01C 21/3626

(57) ABSTRACT

A navigation method and a navigation apparatus are provided. The method includes: determining a location area based on an electronic fence and location coordinates; in response to the location area being a transition area between indoors and outdoors, using a visual positioning algorithm to determine a starting point of motion and using a visual-inertial odometry to collect inertial motion information; and generating augmented reality navigation for the motion in the transition area, based on the starting point of the motion and the inertial motion information.

### CROSS-REFERENCE TO RELATED APPLICATIONS

This patent application claims the priority of Chinese Patent Application No. 202110856976.9, filed on Jul. 28, 2021, and entitled “Navigation Method, Navigation Apparatus, Electronic Device, Storage Medium and Computer Program Product”, the entire content of which is herein incorporated by reference.

### TECHNICAL FIELD

The present disclosure relates to the technical field of data processing, specifically to the technical field of artificial intelligence such as augmented reality, smart navigation, image recognition, and cloud services, and in particular, to a navigation method, a navigation apparatus, an electronic device, and a computer readable storage medium.

### BACKGROUND

Currently, it is common to provide separate augmented reality navigation for outdoors and indoors respectively, and there is no suitable solution for a transition area between the indoors and the outdoors, which makes many users go back and forth in the transition area.

### SUMMARY

Embodiments of the present disclosure provide a navigation method, a navigation apparatus, an electronic device, and a computer readable storage medium.

In a first aspect, an embodiment of the present disclosure provides a navigation method. The method includes: determining a location area based on an electronic fence and location coordinates; in response to the location area being a transition area between indoors and outdoors, using a visual positioning algorithm to determine a starting point of motion and using a visual-inertial odometry to collect inertial motion information; and generating augmented reality navigation for the motion in the transition area, based on the starting point of the motion and the inertial motion information.

In a second aspect, an embodiment of the present disclosure provides a navigation apparatus. The apparatus includes: a location area determining unit, configured to determine a location area based on an electronic fence and location coordinates; a transition area function enable unit, configured to, in response to the location area being a transition area between indoors and outdoors, use a visual positioning algorithm to determine a starting point of motion and use a visual-inertial odometry to collect inertial motion information; and a transition area augmented reality navigation generating unit, configured to generate augmented reality navigation for the motion in the transition area, based on the starting point of the motion and the inertial motion information.

In a third aspect, an embodiment of the present disclosure provides an electronic device. The electronic device includes: at least one processor; and a memory communicatively connected to the at least one processor. The memory stores instructions executable by the at least one processor, and the instructions, when executed by the at least one processor, cause the at least one processor to perform the navigation method according to any implementation in the first aspect.

In a fourth aspect, an embodiment of the present disclosure provides a non-transitory computer readable storage medium storing computer instructions. The computer instructions are used to cause a computer to perform the navigation method according to any implementation in the first aspect.

The navigation method provided by the embodiments of the present disclosure includes: first, determining a location area based on an electronic fence and location coordinates; then, in response to the location area being a transition area between indoors and outdoors, using a visual positioning algorithm to determine a starting point of motion and using a visual-inertial odometry to collect inertial motion information; and finally generating augmented reality navigation for the motion in the transition area, based on the starting point of the motion and the inertial motion information.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

After reading detailed descriptions of non-limiting embodiments with reference to the following accompanying drawings, other features, objectives and advantages of the present disclosure will become more apparent.

FIG. 1 is an exemplary system architecture to which embodiments of the present disclosure may be implemented;

FIG. 2 is a flowchart of a navigation method provided in an embodiment of the present disclosure;

FIG. 3 is a schematic structural diagram of indoors, a transition area, and outdoors set based on an electronic fence provided in an embodiment of the present disclosure;

FIG. 4 is a flowchart of another navigation method provided in an embodiment of the present disclosure;

FIG. 5 is a schematic diagram of selecting a corresponding augmented reality navigation mode based on a location area, provided in an embodiment of the present disclosure;

FIG. 6 is a structural block diagram of a navigation apparatus provided in an embodiment of the present disclosure; and

FIG. 7 is a schematic structural diagram of an electronic device adapted to executing the navigation method provided in embodiments of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described here without departing from the scope and spirit of the present disclosure. Similarly, for clearness and conciseness, descriptions of well-known functions and structures are omitted in the following description. It should be noted that the embodiments in the present disclosure and features in the embodiments may be combined with each other on a non-conflict basis.

In the technical solutions of the present disclosure, the acquisition, storage, and application of involved user personal information are in conformity with relevant laws and regulations, which adopt necessary security measures and do not violate public order and good customs.

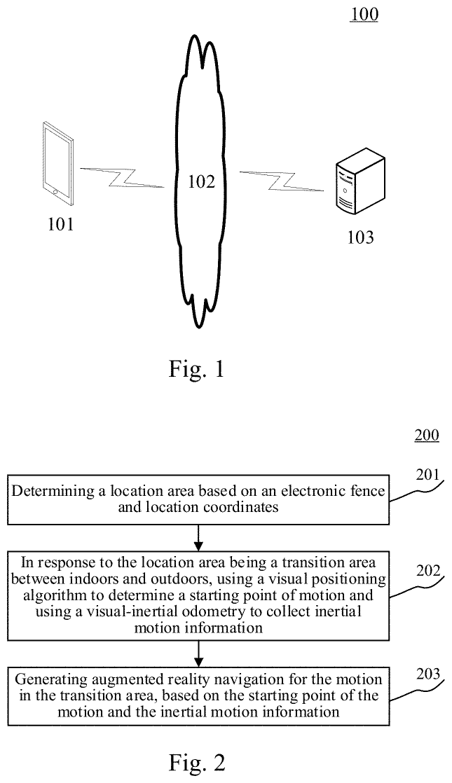

FIG. 1 shows an exemplary system architecture 100 to which embodiments of a navigation method, a navigation apparatus, an electronic device, and a computer readable storage medium of the present disclosure may be implemented.

As shown in FIG. 1, the system architecture 100 may include a mobile terminal 101, a network 102, and a server 103. The network 102 serves as a medium providing a communication link between the mobile terminal 101 and the server 103. The network 102 may include various types of connections, such as wired or wireless communication links, or optical cables.

The user may use the mobile terminal 101 to interact with the server 103 through the network 102 to receive or send messages and the like. Various applications for implementing information communication between the mobile terminal 101 and the server 103 may be installed on the mobile terminal 101 and the server 103, such as full-scene augmented reality navigation applications, visual positioning applications, and instant messaging applications.

The mobile terminal 101 and the server 103 may be hardware or software. When the mobile terminal 101 is hardware, it may be various electronic devices having a display screen, including but not limited to smart phones, tablet computers, laptop computers and desktop computers, etc.; when the mobile terminal 101 is software, it may be installed in the electronic devices listed above, it may be implemented as a plurality pieces of software or a plurality of software modules, or may be implemented as a single piece of software or single software module, which is not limited herein. When the server 103 is hardware, it may be implemented as a distributed server cluster composed of a plurality of servers, or may be implemented as a single server; when the server is software, it may be implemented as a plurality pieces of software or a plurality of software modules, or as a single piece of software or single software module, which is not limited herein.

The server 103 may provide various services through various built-in applications. Using a full-scene augmented reality navigation application that can provide full-scene augmented reality navigation services as an example, when the server 103 runs the full-scene augmented reality navigation application, the following effects may be achieved: first, receiving location coordinates passed in by the mobile terminal 101 through the network 102; then, determining a location area of the mobile terminal 101 based on a preset electronic fence and the location coordinates; next, in response to the location area being a transition area between indoors and outdoors, using a visual positioning algorithm to determine a starting point of motion and using a visual-inertial odometry to collect inertial motion information; and finally providing augmented reality navigation for the mobile terminal 101 moving in the transition area, based on the starting point of the motion and the inertial motion information.

Since providing augmented reality navigation requires many computing resources and strong computing power, the navigation method provided by the subsequent embodiments of the present disclosure is generally executed by the server 103 having strong computing power and many computing resources, correspondingly, the navigation apparatus is generally also provided in the server 103. But at the same time, it should also be noted that when the mobile terminal 101 also has the required computing power and computing resources, the mobile terminal 101 may also complete the above operations assigned to the server 103 using the full-scene augmented reality navigation application installed on the mobile terminal 101, and a same result as that of the server 103 may be output. Especially when there are a plurality of terminal devices having different computing power at the same time, when the full-scene augmented reality navigation application judges that the terminal device where it is located has strong computing power and many remaining computing resources, the terminal device may be allowed to perform the above operations, thereby appropriately reducing a computing pressure of the server 103. Correspondingly, the navigation apparatus may also be provided in the mobile terminal 101. In this case, the exemplary system architecture 100 may not include the server 103 and the network 102.

It should be understood that the numbers of mobile terminals, networks and servers in FIG. 1 are merely illustrative. There may be any number of mobile terminals, networks and servers according to implementation needs.

With reference to FIG. 2, FIG. 2 is a flowchart of a navigation method provided in an embodiment of the present disclosure, where a flow 200 includes the following steps.

Step 201: determining a location area based on an electronic fence and location coordinates;

This step aims to determine the location area based on the electronic fence and the location coordinates by an executing body (for example, the server 103 shown in FIG. 1) of the navigation method. The location coordinates may not be able to provide accurate values depending on the actual different location areas. For example, when a user is actually in an outdoor area, the location coordinates obtained by a GPS (Global Positioning System) signal in this regard are relatively accurate. If the user is in an indoor area, the location coordinates may be reversed by the coordinates of many fixed objects, and in a transition area, the location coordinates are reversed by means of accurate location coordinates at the moment of leaving from an indoor area or outdoor area and entering the transition area plus inertial motion information.

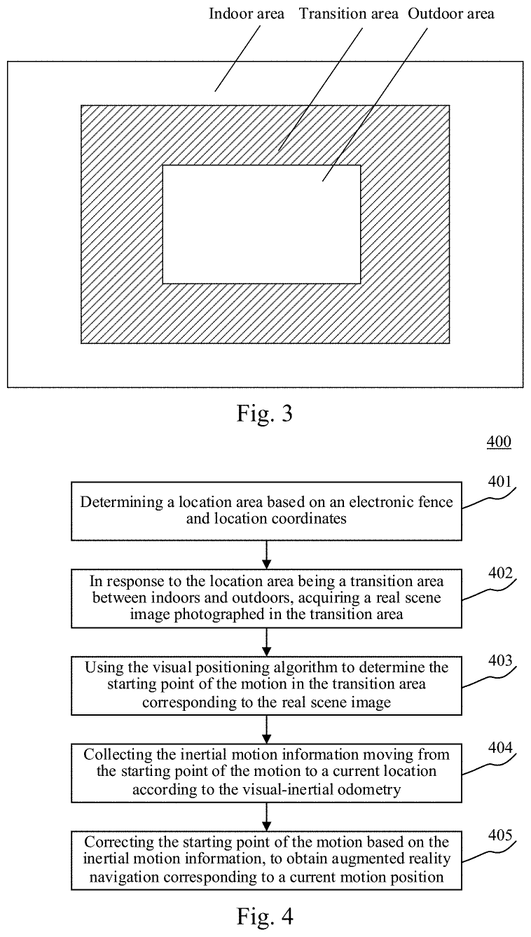

A specific electronic fence and structural information of different areas may refer to the schematic diagram as shown in FIG. 3. As shown in FIG. 3, the outermost area is an outdoor area, and the innermost area is an indoor area, an area between the indoor area and the outdoor area and covered with black slashes is a transition area.

Step 202: in response to the location area being a transition area between indoors and outdoors, using a visual positioning algorithm to determine a starting point of motion and using a visual-inertial odometry to collect inertial motion information;

This step aims to the situation where the location area is the transition area between the indoors and the outdoors, and aims to use the visual positioning algorithm to determine the starting point of the motion and use the visual-inertial odometry to collect the inertial motion information by the executing body.

The visual positioning algorithm is used to provide the starting point of the motion in the transition area by means of image content matching, and the visual-inertial odometry is used to perform inertia correction on the starting point of the motion using the inertial motion information it collects.

There may be a variety of visual positioning algorithms, such as pure visual positioning algorithm, that is, using a real scene image obtained by photographing to perform matching operations in the full amount of image data, if there are a plurality of floors in the transition area or terrain with complex spatial transformation, the matching time is usually longer; Bluetooth visual positioning algorithm that uses Bluetooth information to assist positioning may also be used, that is, it helps determine part of the location information, such as at which floor, by performing Bluetooth communication with a Bluetooth device set in the area.

Visual-Inertial Odometry (VIO), sometimes called Visual-Inertial System (VINS), is an algorithm that integrates camera and IMU (Inertial Measurement Unit) data to achieve SLAM (Simultaneous Localization and Mapping), based on a difference of an integration framework, the algorithm is divided into tight coupling and loose coupling. In loose coupling, visual motion estimation and inertial navigation motion estimation systems are two independent modules, and output results of each module are integrated, while in tight coupling, a set of variables are jointly estimated using raw data of two sensors, and sensor noise also affects each other. Tight coupling is algorithmically more complex, but makes better use of sensor data and may achieve better results. The present disclosure uses this feature of the VIO to assist the starting point of the motion determined by the visual positioning algorithm to correct a current motion position.

It should be noted that the image content obtained when using vision for assisted positioning comes from objects or areas that are allowed to be photographed and used for positioning or navigation, even when sensitive objects or objects that are not allowed to be photographed without authorization are accidentally photographed, the corresponding warning information are allowed to be issued, and the triggering of the warning information can be framed for some special areas through the electronic fence.

Step 203: generating augmented reality navigation for the motion in the transition area, based on the starting point of the motion and the inertial motion information.

On the basis of step 202, this step aims to correct the starting point of the motion using the inertial motion information based on the starting point of the motion and the inertial motion information by the executing body, so as to generate accurate augmented reality navigation for the motion in the transition area.

The navigation method provided by the embodiment of the present disclosure, provides an augmented reality navigation method combining visual positioning algorithm and visual-inertial odometry for a transition area, that is, the visual positioning algorithm is used to provide a starting point of motion in the transition area by means of image content matching, and the visual-inertial odometry is used to perform inertia correction on the starting point of the motion using inertial motion information it collects, so as to correspond a user's travel state in the transition area using the inertial motion information, thereby improving real-time and accurate augmented reality navigation in the transition area. Matched with augmented reality navigation provided for indoor and outdoor areas respectively, full coverage may be achieved, thereby providing users with more comprehensive navigation services.

With reference to FIG. 4, FIG. 4 is a flowchart of another navigation method provided in an embodiment of the present disclosure, where a flow 400 includes the following steps.

Step 401: determining a location area based on an electronic fence and location coordinates.

Step 402: in response to the location area being a transition area between indoors and outdoors, acquiring a real scene image photographed in the transition area.

This step aims to first acquire the real scene image photographed in the transition area by the executing body, and the real scene image may be photographed by a smart mobile terminal (e.g., the mobile terminal 101 as shown in FIG. 1) under the control of a user.

Step 403: using the visual positioning algorithm to determine the starting point of the motion in the transition area corresponding to the real scene image.

On the basis of step 402, this step aims to use the visual positioning algorithm to determine the starting point of the motion in the transition area corresponding to the real scene image by the executing body, that is, the visual positioning algorithm performs similarity matching in pre-stored image data of all objects in the transition area, so as to determine a photographing position based on a similarity matching result, and use the photographing position as the starting point of the motion.

Generally speaking, the real scene image may be an image photographed at any angle and of any object in the transition area by the user using the smart mobile terminal. However, in order to improve a matching efficiency as much as possible, the object to be photographed should be selected as a landmark object that is more conspicuous and easier to identify in the transition area as much as possible. If an object in an outdoor area or an indoor area can be photographed through the transition area, the starting point of the motion may also be roughly estimated by a photographing angle, an actual size of the photographed object, and a size in the image.

Step 404: collecting the inertial motion information moving from the starting point of the motion to a current location according to the visual-inertial odometry.

On the basis of step 403, this step aims to collect the inertial motion information moving from the starting point of the motion to the current location according to the visual-inertial odometry by the executing body. That is, the user may still be in a motion state after obtaining the real scene image by photographing, therefore, recording the inertial motion information in this motion state can fully restore a position change in the transition area.

Step 405: correcting the starting point of the motion based on the inertial motion information, to obtain augmented reality navigation corresponding to a current motion position.

On the basis of step 404, this step aims to correct the starting point of the motion based on the inertial motion information by the executing body, to obtain the augmented reality navigation corresponding to the current motion position.

Further, the smart mobile terminal may also be controlled to periodically photograph new real scene images to assist in determining real-time location information. If there is a Bluetooth device in the area that can assist in determining the location information using Bluetooth signals, the current actual location may also be adjusted using collected Bluetooth positioning signals, thereby improving the effect of augmented reality navigation in the transition area. For example, a Bluetooth signal sent by a Bluetooth device preset in the transition area is collected, and then a current navigation location is adjusted based on location information corresponding to the Bluetooth signal.

It should be noted that the Bluetooth positioning signals that can be collected in the present disclosure all come from Bluetooth tags specially designed to provide positioning signals or Bluetooth devices authorized by owners or users to broadcast location information to the outside world. Therefore, the Bluetooth signals used are compliant.

In addition, when a travel direction is from the transition area to an outdoor area, in order to avoid an error caused by gradual amplification of the inertial motion information in a continuous process, a degree of stability of continuously received GPS signals may also be determined; therefore, it may be determined whether it is leaving from the transition area to the outdoor area, based on the degree of stability. For example, when the degree of stability is greater than a preset degree, a current location of the augmented reality navigation may be adjusted to the outdoor area, and a reminder that the transition area has been exited may be sent. The present embodiment is based on the situation that the closer to the outdoor area, the higher the degree of stability of the GPS signals.

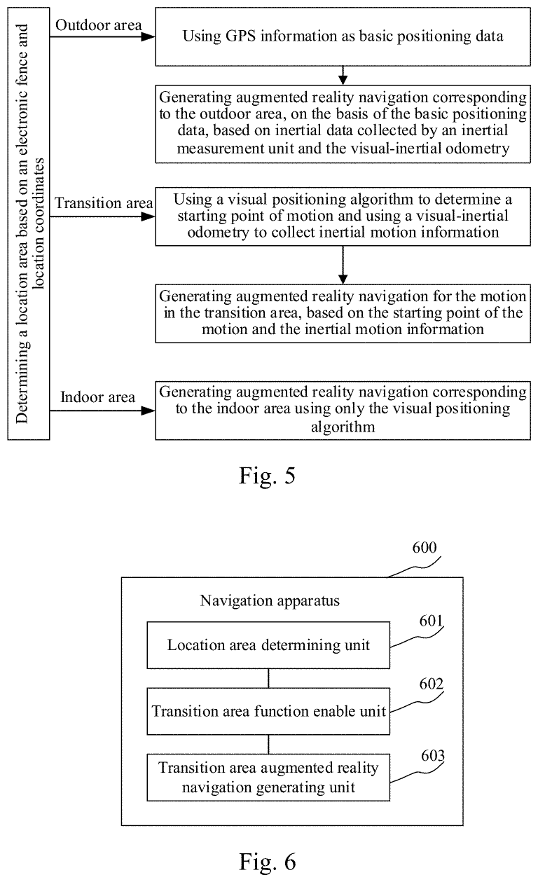

In order to deepen the understanding to actual technical effects of the solutions provided by the present disclosure, the present disclosure also provides an all-region coverage and seamless switching augmented reality navigation solution by combining the augmented reality navigation solutions for an outdoor area and an indoor area through the schematic diagram shown in FIG. 5:

First: determining a location area based on an electronic fence and location coordinates;

When the location area is an outdoor area, using GPS information as basic positioning data, then generating augmented reality navigation corresponding to the outdoor area, on the basis of the basic positioning data, based on inertial data collected by an inertial measurement unit and the visual-inertial odometry;

when the location area is a transition area, using a visual positioning algorithm to determine a starting point of motion and using a visual-inertial odometry to collect inertial motion information, then generating augmented reality navigation for the motion in the transition area, based on the starting point of the motion and the inertial motion information; and

when the location area is an indoor area, generating augmented reality navigation corresponding to the indoor area using only the visual positioning algorithm.

It can be seen that when the user travels from the outdoor area to the indoor area through the transition area, the GPS, IMU and VIO functional components are first turned on to provide the augmented reality navigation for the outdoor area; then the GPS and the IMU that cannot provide position reference are turned off after entering the transition area, and the visual positioning algorithm is turned on to provide the augmented reality navigation for the transition area using the visual positioning algorithm and the VIO functional component; finally, after entering the indoor area, due to the complexity of the indoor area, the VIO functional component that cannot provide accurate inertial information is turned off, only the visual positioning algorithm is used to provide the augmented reality navigation for the indoor area.

To deepen understanding, the present disclosure also provides an implementation scheme in combination with an application scenario. Assuming that a user A is currently at an outdoor X, the destination is a Y store on the 7th floor of a shopping center, and the user passes through a transition area outside the shopping center. Therefore, the user A may finally reach the store Y using all-region augmented reality navigation services provided by the following steps.

1) An all-region augmented reality navigation application divides an entire navigation into three phases based on the starting point and the destination, namely an outdoor navigation phase from X to an entrance of the transition area, a transition area navigation phase from the entrance of the transition area to an entrance on the 1st floor of the shopping center, and an indoor navigation phase from the entrance on the 1st floor of the shopping center to the Y store on the 7th floor.

2) The all-region augmented reality navigation application calls GPS, IMU and VIO functional components to provide the user A with outdoor augmented reality navigation from X to the entrance of the transition area.

3) The all-region augmented reality navigation application perceives that the user A is currently traveling to the transition area, and requires the user A to obtain a first real scene image for positioning by photographing in the transition area.

4) The all-region augmented reality navigation application calls a visual positioning component to determine an entry point to the transition area corresponding to the first real scene image for positioning.

5) The all-region augmented reality navigation application calls the VIO component to acquire inertial motion information from the photographing of the first real scene image for positioning to the current time point.

6) The all-region augmented reality navigation application corrects the entry point to the transition area based on the inertial motion information, so as to provide augmented reality navigation to the entrance on the 1st floor of the shopping center based on a current location of the user A in the transition area, and the whole process is obtained based on newly photographed real scene images and inertial motion information updated regularly.

7) The all-region augmented reality navigation application perceives that the user A enters the outdoors, closes the VIO component, and calls a camera component to cooperate with a visual positioning algorithm to provide indoor augmented reality navigation to the Y store on the 7th floor.

With further reference to FIG. 6, as an implementation of the method shown in the above figures, the present disclosure provides an embodiment of a navigation apparatus. The apparatus embodiment corresponds to the method embodiment as shown in FIG. 2. The apparatus may be applied to various electronic devices.

As shown in FIG. 6, a navigation apparatus 600 of the present embodiment may include: a location area determining unit 601, a transition area function enable unit 602, and a transition area augmented reality navigation generating unit 603. The location area determining unit 601 is configured to determine a location area based on an electronic fence and location coordinates. The transition area function enable unit 602 is configured to, in response to the location area being a transition area between indoors and outdoors, use a visual positioning algorithm to determine a starting point of motion and use a visual-inertial odometry to collect inertial motion information. The transition area augmented reality navigation generating unit 603 is configured to generate augmented reality navigation for the motion in the transition area, based on the starting point of the motion and the inertial motion information.

In the present embodiment, in the navigation apparatus 600, for the specific processing and the technical effects of the location area determining unit 601, the transition area function enable unit 602, and the transition area augmented reality navigation generating unit 603, reference may be made to the relevant descriptions of steps 201-203 in the corresponding embodiment of FIG. 2 respectively, and repeated description thereof will be omitted.

In some alternative implementations of the present embodiment, the transition area function enable unit 602 may be further configured to: acquire a real scene image photographed in the transition area; use the visual positioning algorithm to determine the starting point of the motion in the transition area corresponding to the real scene image; and collect the inertial motion information moving from the starting point of the motion to a current location according to the visual-inertial odometry.

In some alternative implementations of the present embodiment, the apparatus 600 may further include: a basic positioning data acquiring unit, configured to, in response to the location area being an outdoor area, use GPS information as basic positioning data; and an outdoor area augmented reality navigation generating unit, configured to generate augmented reality navigation corresponding to the outdoor area, on the basis of the basic positioning data, based on inertial data collected by an inertial measurement unit and the visual-inertial odometry.

In some alternative implementations of the present embodiment, the apparatus 600 may further include: an indoor area augmented reality navigation generating unit, configured to, in response to the location area being an indoor area, generate augmented reality navigation corresponding to the indoor area using only the visual positioning algorithm.

In some alternative implementations of the present embodiment, the apparatus 600 may further include: a stability degree determining unit, configured to determine a degree of stability of continuously received GPS signals, in response to a travel direction being from the transition area to an outdoor area; and a positioning area adjusting unit, configured to, in response to the degree of stability being greater than a preset degree, adjust a current location of the augmented reality navigation to the outdoor area, and send a reminder that the transition area has been exited.

In some alternative implementations of the present embodiment, in a process of providing the augmented reality navigation for the transition area, the apparatus 600 may further include: a Bluetooth signal collecting unit, configured to collect a Bluetooth signal sent by a Bluetooth device preset in the transition area; and a current navigation location adjusting unit, configured to adjust a current navigation location based on location information corresponding to the Bluetooth signal.

The present embodiment exists as an apparatus embodiment corresponding to the above method embodiment, the navigation apparatus provided by the present embodiment, provides an augmented reality navigation method combining visual positioning algorithm and visual-inertial odometry for a transition area, that is, the visual positioning algorithm is used to provide a starting point of motion in the transition area by means of image content matching, and the visual-inertial odometry is used to perform inertia correction on the starting point of the motion using inertial motion information it collects, so as to correspond a user's travel state in the transition area using the inertial motion information, thereby improving real-time and accurate augmented reality navigation in the transition area. Matched with augmented reality navigation provided for indoor and outdoor areas respectively, full coverage may be achieved, thereby providing users with more comprehensive navigation services.

According to an embodiment of the present disclosure, the present disclosure also provides an electronic device, the electronic device including: at least one processor, and a memory communicatively connected to the at least one processor. The memory stores instructions executable by the at least one processor, and the instructions, when executed by the at least one processor, cause the at least one processor to implement the navigation method described in any one of the above embodiments.

According to an embodiment of the present disclosure, the present disclosure also provides a readable storage medium, the readable storage medium stores computer instructions, and the computer instructions are used to cause the computer to implement the navigation method described in any one of the above embodiments.

An embodiment of the present disclosure provides a computer program product, the computer program product, when executed by a processor, can implement the navigation method described in any one of the above embodiments.

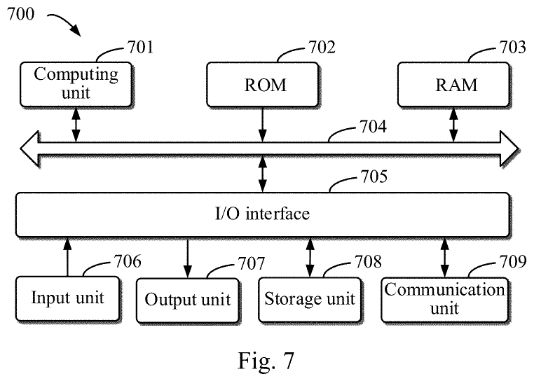

FIG. 7 shows a schematic block diagram of an example electronic device 700 that may be used to implement embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 7, the device 700 includes a computing unit 701, which may perform various appropriate actions and processing, based on a computer program stored in a read-only memory (ROM) 702 or a computer program loaded from a storage unit 708 into a random access memory (RAM) 703. In the RAM 703, various programs and data required for the operation of the device 700 may also be stored. The computing unit 701, the ROM 702, and the RAM 703 are connected to each other through a bus 704. An input/output (I/O) interface 705 is also connected to the bus 704.

A plurality of components in the device 700 are connected to the I/O interface 705, including: an input unit 706, for example, a keyboard and a mouse; an output unit 707, for example, various types of displays and speakers; the storage unit 708, for example, a disk and an optical disk; and a communication unit 709, for example, a network card, a modem, or a wireless communication transceiver. The communication unit 709 allows the device 700 to exchange information/data with other devices over a computer network such as the Internet and/or various telecommunication networks.

The computing unit 701 may be various general-purpose and/or dedicated processing components having processing and computing capabilities. Some examples of the computing unit 701 include, but are not limited to, central processing unit (CPU), graphics processing unit (GPU), various dedicated artificial intelligence (AI) computing chips, various computing units running machine learning model algorithms, digital signal processor (DSP), and any appropriate processors, controllers, microcontrollers, etc. The computing unit 701 performs the various methods and processes described above, such as the navigation method. For example, in some embodiments, the navigation method may be implemented as a computer software program, which is tangibly included in a machine readable medium, such as the storage unit 708. In some embodiments, part or all of the computer program may be loaded and/or installed on the device 700 via the ROM 702 and/or the communication unit 709. When the computer program is loaded into the RAM 703 and executed by the computing unit 701, one or more steps of the navigation method described above may be performed. Alternatively, in other embodiments, the computing unit 701 may be configured to perform the navigation method by any other appropriate means (for example, by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The server may be a cloud server, also known as a cloud computing server or a cloud host. It is a host product in the cloud computing service system to solve the defects in traditional physical host and virtual private server (VPS) services, such as large management difficulties, and weak business expansion.

According to the technical solutions of the embodiments of the present disclosure, an augmented reality navigation method combining visual positioning algorithm and visual-inertial odometry for a transition area is provided, that is, the visual positioning algorithm is used to provide a starting point of motion in the transition area by means of image content matching, and the visual-inertial odometry is used to perform inertia correction on the starting point of the motion using inertial motion information it collects, so as to correspond a user's travel state in the transition area using the inertial motion information, thereby improving real-time and accurate augmented reality navigation in the transition area. Matched with augmented reality navigation provided for indoor and outdoor areas respectively, full coverage may be achieved, thereby providing users with more comprehensive navigation services.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A navigation method, comprising:
determining a location area based on an electronic fence and location coordinates;
in response to the location area being a transition area between indoors and outdoors, using a visual positioning algorithm to determine a starting point of motion and using a visual-inertial odometry to collect inertial motion information; and
generating augmented reality navigation for the motion in the transition area, based on the starting point of the motion and the inertial motion information.

2. The method according to claim 1, wherein using the visual positioning algorithm to determine the starting point of motion and using the visual-inertial odometry to collect inertial motion information, comprises:
acquiring a real scene image photographed in the transition area;
using the visual positioning algorithm to determine the starting point of the motion in the transition area corresponding to the real scene image; and
collecting the inertial motion information moving from the starting point of the motion to a current location according to the visual-inertial odometry.

3. The method according to claim 1, further comprising:
in response to the location area being an outdoor area, using GPS information as basic positioning data; and
generating augmented reality navigation corresponding to the outdoor area, based on the basic positioning data and a plurality of inertial data collected by an inertial measurement unit and the visual-inertial odometry.

4. The method according to claim 1, further comprising:
in response to the location area being an indoor area, generating augmented reality navigation corresponding to the indoor area using only the visual positioning algorithm.

5. The method according to claim 1, further comprising:
in response to a travel direction being from the transition area to an outdoor area, determining a degree of stability of continuously received GPS signals; and
in response to the degree of stability being greater than a preset degree, adjusting a current location of the augmented reality navigation to the outdoor area, and sending a reminder that the transition area has been exited.

6. The method according to claim 1, wherein, in a process of providing the augmented reality navigation for the transition area, the method further comprises:
collecting a Bluetooth signal sent by a Bluetooth device preset in the transition area; and
adjusting a current navigation location based on location information corresponding to the Bluetooth signal.

7. An electronic device, comprising:
at least one processor; and
a memory communicatively connected to the at least one processor;
wherein the memory is configured to store instructions executable by the at least one processor, and the instructions, when executed by the at least one processor, cause the at least one processor to perform operations, the operations comprising:
determining a location area based on an electronic fence and location coordinates;
in response to the location area being a transition area between indoors and outdoors, using a visual positioning algorithm to determine a starting point of motion and using a visual-inertial odometry to collect inertial motion information; and
generating augmented reality navigation for the motion in the transition area, based on the starting point of the motion and the inertial motion information.

8. The electronic device according to claim 7, wherein using the visual positioning algorithm to determine the starting point of motion and using the visual-inertial odometry to collect inertial motion information, comprises:
acquiring a real scene image photographed in the transition area;
using the visual positioning algorithm to determine the starting point of the motion in the transition area corresponding to the real scene image; and
collecting the inertial motion information moving from the starting point of the motion to a current location according to the visual-inertial odometry.

9. The electronic device according to claim 7, wherein the operations further comprise:
in response to the location area being an outdoor area, using GPS information as basic positioning data; and
generating augmented reality navigation corresponding to the outdoor area, based on the basic positioning data and a plurality of inertial data collected by an inertial measurement unit and the visual-inertial odometry.

10. The electronic device according to claim 7, wherein the operations further comprise:
in response to the location area being an indoor area, generating augmented reality navigation corresponding to the indoor area using only the visual positioning algorithm.

11. The electronic device according to claim 7, wherein the operations further comprise:
in response to a travel direction being from the transition area to an outdoor area, determining a degree of stability of continuously received GPS signals; and
in response to the degree of stability being greater than a preset degree, adjusting a current location of the augmented reality navigation to the outdoor area, and sending a reminder that the transition area has been exited.

12. The electronic device according to claim 7, wherein determining the location area further comprises:
collecting a Bluetooth signal sent by a Bluetooth device preset in the transition area; and
adjusting a current navigation location based on location information corresponding to the Bluetooth signal.

13. A non-transitory computer readable storage medium storing computer instructions, wherein the computer instructions, when executed by a processor, cause the processor to perform operations, the operations comprising:
determining a location area based on an electronic fence and location coordinates;
in response to the location area being a transition area between indoors and outdoors, using a visual positioning algorithm to determine a starting point of motion and using a visual-inertial odometry to collect inertial motion information; and
generating augmented reality navigation for the motion in the transition area, based on the starting point of the motion and the inertial motion information.

14. The non-transitory computer readable storage medium according to claim 13, wherein using the visual positioning algorithm to determine the starting point of motion and using the visual-inertial odometry to collect inertial motion information, comprises:
acquiring a real scene image photographed in the transition area;
using the visual positioning algorithm to determine the starting point of the motion in the transition area corresponding to the real scene image; and
collecting the inertial motion information moving from the starting point of the motion to a current location according to the visual-inertial odometry.

15. The non-transitory computer readable storage medium according to claim 13, wherein the operations further comprise:
in response to the location area being an outdoor area, using GPS information as basic positioning data; and
generating augmented reality navigation corresponding to the outdoor area, based upon the basic positioning data and a plurality of inertial data collected by an inertial measurement unit and the visual-inertial odometry.

16. The non-transitory computer readable storage medium according to claim 13, wherein the operations further comprise:
in response to the location area being an indoor area, generating augmented reality navigation corresponding to the indoor area using only the visual positioning algorithm.

17. The non-transitory computer readable storage medium according to claim 13, wherein the operations further comprise:
in response to a travel direction being from the transition area to an outdoor area, determining a degree of stability of continuously received GPS signals; and
in response to the degree of stability being greater than a preset degree, adjusting a current location of the augmented reality navigation to the outdoor area, and sending a reminder that the transition area has been exited.

18. The non-transitory computer readable storage medium according to claim 13, wherein determining the location area further comprises:
collecting a Bluetooth signal sent by a Bluetooth device preset in the transition area; and
adjusting a current navigation location based on location information corresponding to the Bluetooth signal.
